(19) United States
(12) Patent Application Publication
(10) Pub. No.: US 2017/0271813 A1
(43) Pub. Date: Sep. 21, 2017

(54) ELECTRICAL CONNECTOR HAVING INSERT MOLDED HOLDING MEMBERS

(71) Applicant: FOXCONN INTERCONNECT TECHNOLOGY LIMITED, Grand Cayman (KY)

(72) Inventors: MING-QI GE, Kunshan (CN); LI-DONG TANG, Kunshan (CN); XIAO-LI ZHU, Kunshan (CN); XING-CHEN QIAN, Kunshan (CN); XIAN-DONG BAO, Kunshan (CN)

(21) Appl. No.: 15/461,505

(22) Filed: Mar. 17, 2017

(30) Foreign Application Priority Data
Mar. 17, 2016 (CN) 201620204224.9
Mar. 17, 2016 (CN) 201620204225.3

(51) Int. Cl. H01R 13/627; H01R 12/71; H01R 13/405

(52) U.S. Cl. CPC H01R 13/6275; H01R 13/6278; H01R 13/405; H01R 12/716

(57) ABSTRACT

An electrical connector includes an insulative housing; plural contacts secured to the insulative housing, and a pair of holding members insert molded with the insulative housing, the holding member including a base, a pair of arms extending from the base, and a pair of contact portions bent inwardly from the arms, wherein the base is embedded in the insulative housing. Also an electrical connector includes an insulative housing, plural contacts secured to the insulative housing, and a pair of holding members insert molded with the insulative housing, each holding member including a base, a pair of arms extending from the base, and a head bent inwardly from the base, wherein the base is embedded in the insulative housing.

### BACKGROUND OF THE INVENTION

1. Field of the Invention

The present invention relates to a board to board connector having a pair of holding members insert molded with an insulative housing thereof.

2. Description of Related Art

U.S. Patent Application Publication No. 2014/0227899, published on Aug. 14, 2014, discloses a socket-side holding metal fitting formed integrated with a socket housing by insert molding. The metal fitting includes a side plate portion extending in a width direction. The side plate portion has extended portions bent in a longitudinal direction. A claw portion which is bent into an inverted U-shape is provided at a terminal end portion of each extended portion. The side plate portion is exposed to an outside. A lock hole is formed on a tip end side of the claw portion.

U.S. Pat. No. 8,845,339, issued on Sep. 30, 2014, discloses a metal fitting mounted to an insulative housing end portion. The end portion includes an indentation having a contiguous U-shape. The metal fitting includes a main body, plate portions extending in a longitudinal direction, a lateral board connection portion connected to a lower end of the plate portion, a lateral contact arm portion connected to an upper end of the plate portion, a central board connection portion connected to a lower end of the main body, and a central contact arm portion connected to an upper central end of the main body.

U.S. Pat. No. 9,350,097, issued on May 24, 2016, also discloses a guide metal member that separately mounted to a side wall attachment section of an insulative housing circumferential wall.

An electrical connector having robust holding members is desired.

### SUMMARY OF THE INVENTION

In one aspect, an electrical connector comprises: an insulative housing; a plurality of contacts secured to the insulative housing; and a pair of holding members insert molded with the insulative housing, the holding member including a base, a pair of arms extending from the base, and a pair of contact portions bent inwardly from the arms; wherein the base is embedded in the insulative housing. In another aspect, an electrical connector comprises: an insulative housing; a plurality of contacts secured to the insulative housing; and a pair of holding members insert molded with the insulative housing, each holding member including a base, a pair of arms extending from the base, and a head bent inwardly from the base; wherein the base is embedded in the insulative housing.

### BRIEF DESCRIPTION OF THE DRAWINGS

FIG. 1 is an assembled perspective view showing an electrical connector assembly in accordance with a first embodiment of the present invention;

FIG. 2 is another assembled view of the electrical connector assembly in FIG. 1 from an opposite perspective;

FIG. 3 is an exploded perspective view of a receptacle connector and a plug connector of the electrical connector assembly in FIG. 1;

FIG. 4 is another exploded perspective view of the receptacle connector and the plug connector in FIG. 1;

FIG. 5 is an exploded view of the receptacle connector in FIG. 1;

FIG. 6 is another exploded view of the receptacle connector in FIG. 1 from an opposite perspective;

FIG. 7 is an exploded view of the plug connector in FIG. 1;

FIG. 8 is another exploded view of the plug connector in FIG. 1 from an opposite perspective;

FIG. 9 is an assembled perspective view showing an electrical connector assembly in accordance with a second embodiment of the present invention;

FIG. 10 is another assembled view of the electrical connector assembly in FIG. 9 from an opposite perspective;

FIG. 11 is an exploded perspective view of a receptacle connector and a plug connector of the electrical connector assembly in FIG. 9;

FIG. 12 is another exploded perspective view of the receptacle connector and the plug connector in FIG. 9;

FIG. 13 is an exploded view of the receptacle connector in FIG. 9;

FIG. 14 is another exploded view of the receptacle connector in FIG. 9 from an opposite perspective;

FIG. 15 is an exploded view of the plug connector in FIG. 9;

FIG. 16 is another exploded view of the plug connector in FIG. 9 from an opposite perspective;

FIG. 17 is an assembled perspective view showing an electrical connector assembly in accordance with a third embodiment of the present invention;

FIG. 18 is another assembled view of the electrical connector assembly in FIG. 17 from an opposite perspective;

FIG. 19 is an exploded perspective view of a receptacle connector and a plug connector of the electrical connector assembly in FIG. 17;

FIG. 20 is another exploded perspective view of the receptacle connector and the plug connector in FIG. 17;

FIG. 21 is an exploded view of the receptacle connector in FIG. 17;

FIG. 22 is another exploded view of the receptacle connector in FIG. 17 from an opposite perspective;

FIG. 23 is an exploded view of the plug connector in FIG. 17;

FIG. 24 is another exploded view of the plug connector in FIG. 17 from an opposite perspective;

FIG. 25 is an assembled perspective view showing an electrical connector assembly in accordance with a fourth embodiment of the present invention;

FIG. 26 is another assembled view of the electrical connector assembly in FIG. 25 from an opposite perspective;

FIG. 27 is an exploded perspective view of a receptacle connector and a plug connector of the electrical connector assembly in FIG. 25;

FIG. 28 is another exploded perspective view of the receptacle connector and the plug connector in FIG. 25;

FIG. 29 is an exploded view of the receptacle connector in FIG. 25;

FIG. 30 is another exploded view of the receptacle connector in FIG. 25 from an opposite perspective;

FIG. 31 is an exploded view of the plug connector in FIG. 25;

FIG. 32 is another exploded view of the plug connector in FIG. 25 from an opposite perspective;

FIG. 33 is a cross-sectional view to show the mated connector assembly of FIG. 1;

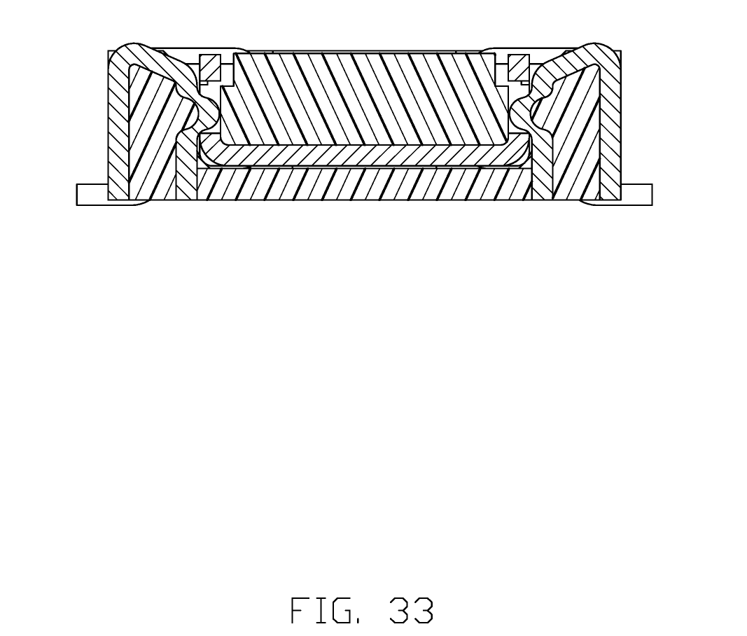

FIG. 34 is a cross-sectional view to show the mated connector assembly of FIG. 9;

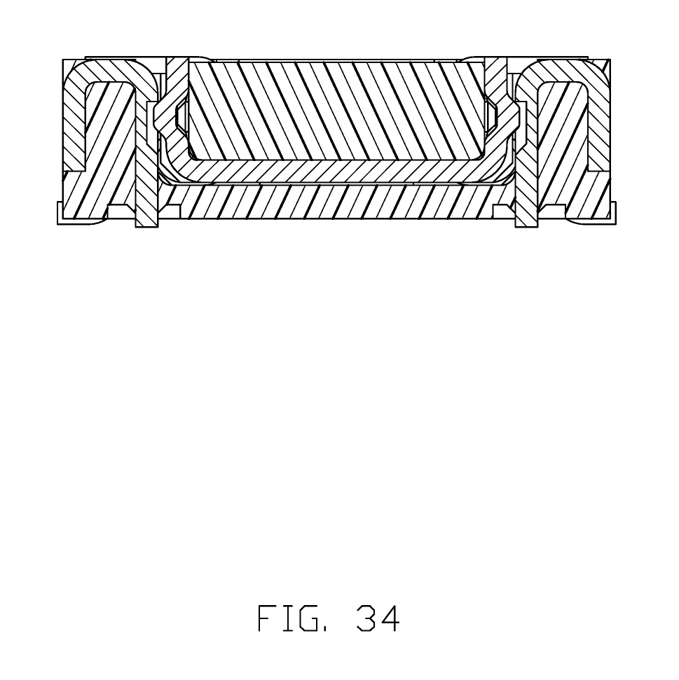

FIG. 35 is a cross-sectional view to show the mated connector assembly of FIG. 17; and

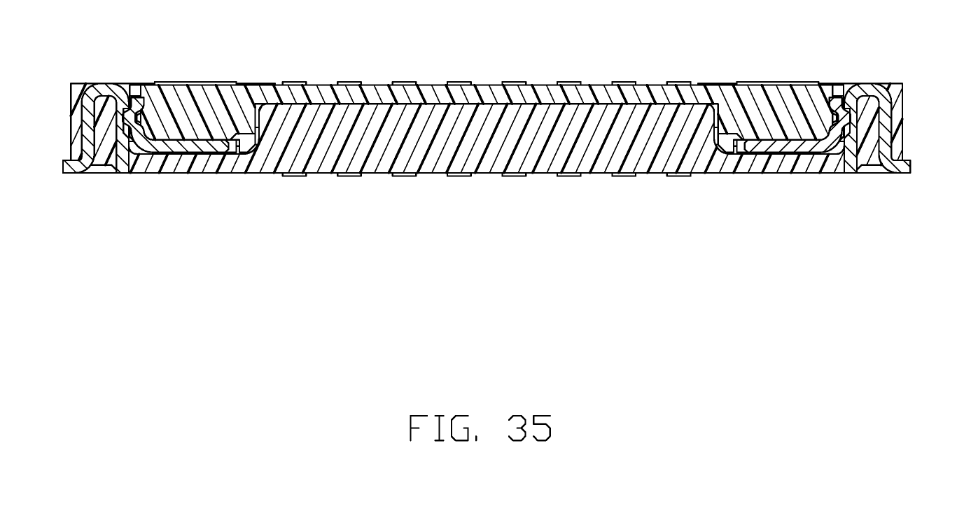

FIG. 36 is a cross-sectional view to show the mated connector assembly of FIG. 25.

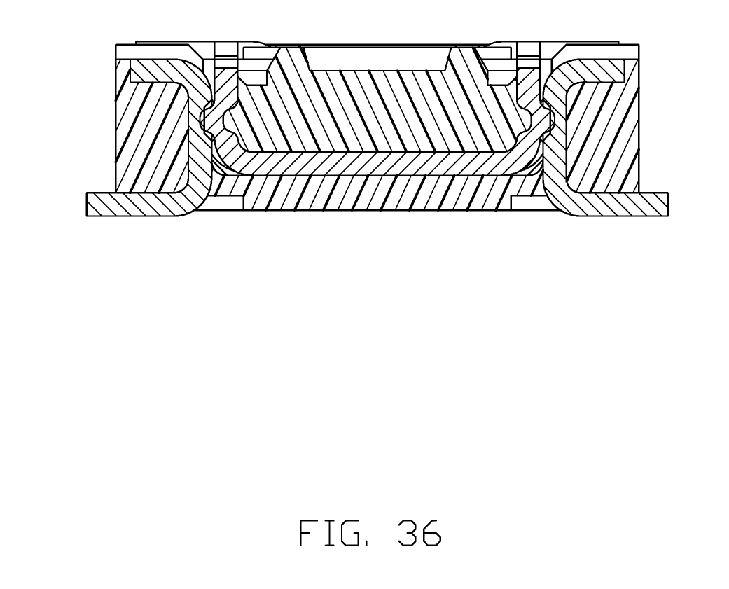

### DETAILED DESCRIPTION OF THE PREFERRED EMBODIMENT

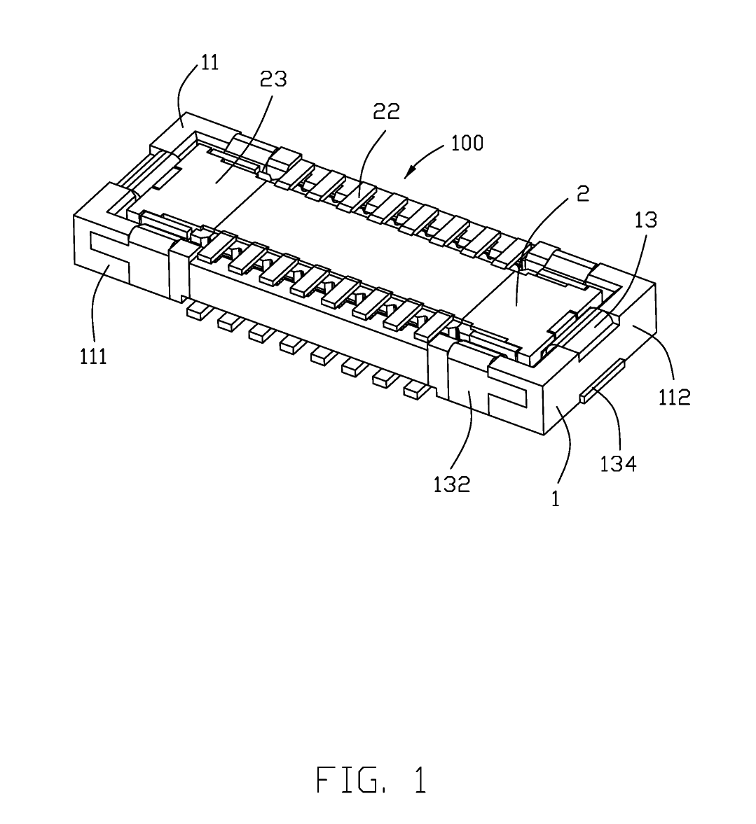

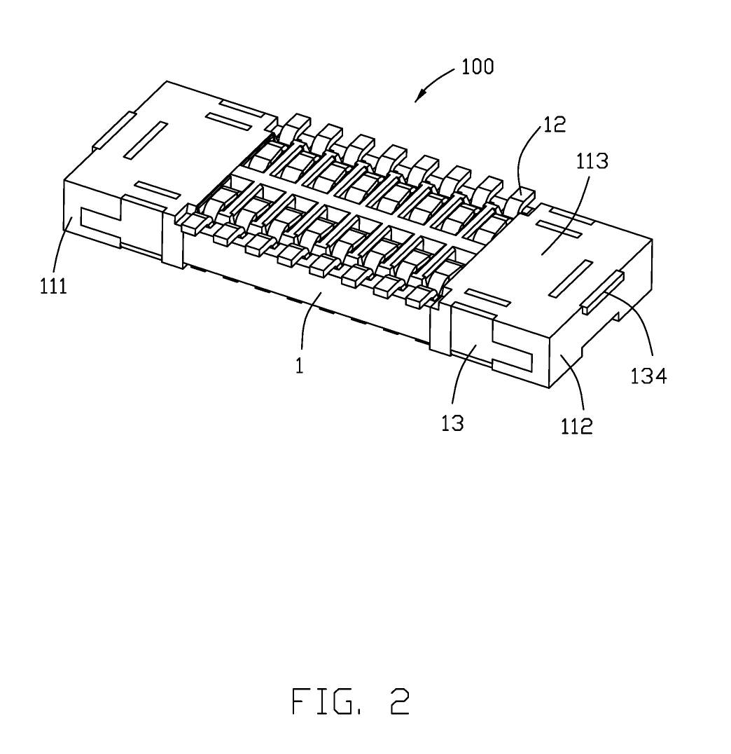

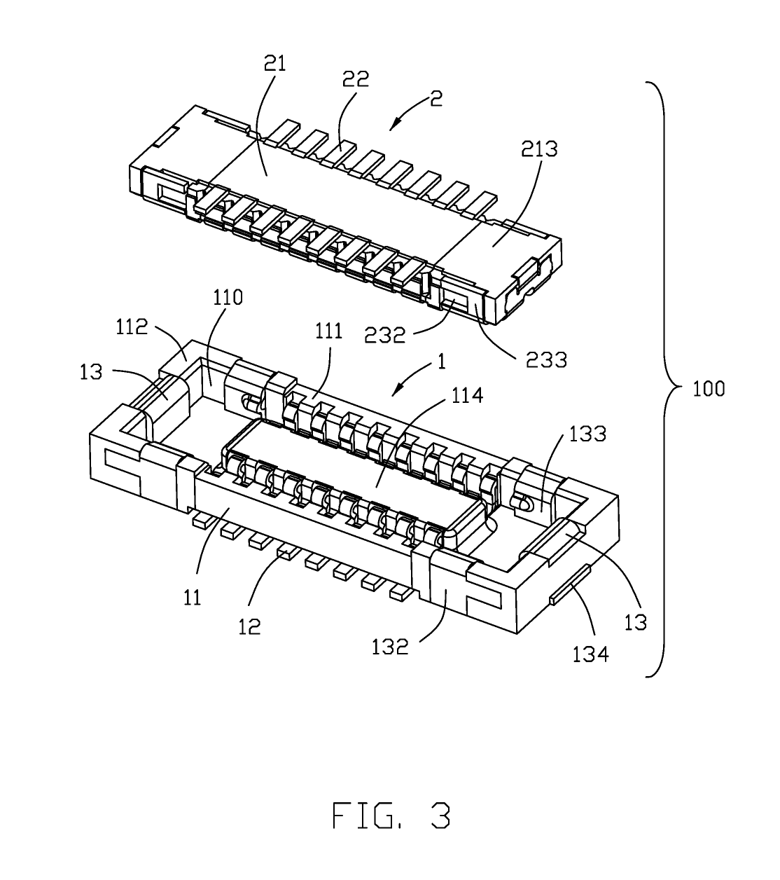

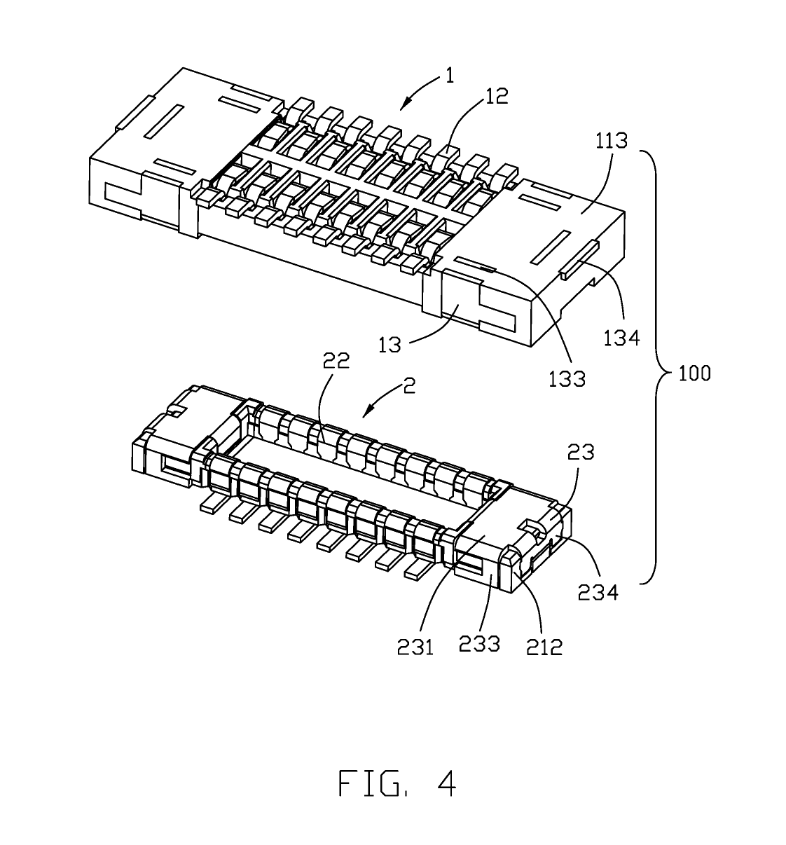

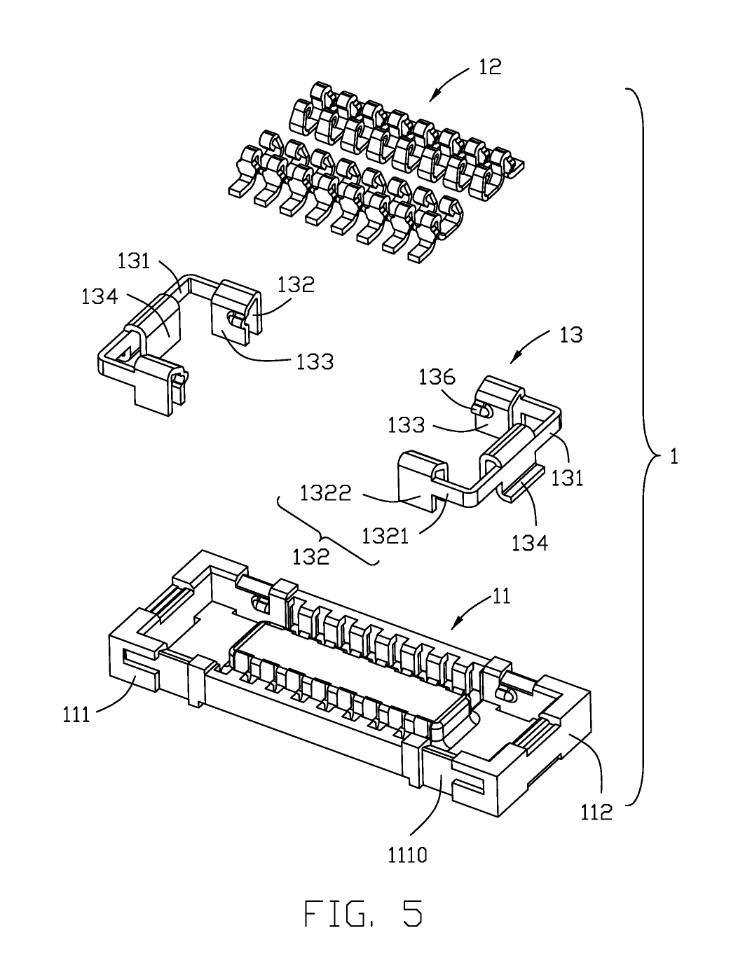

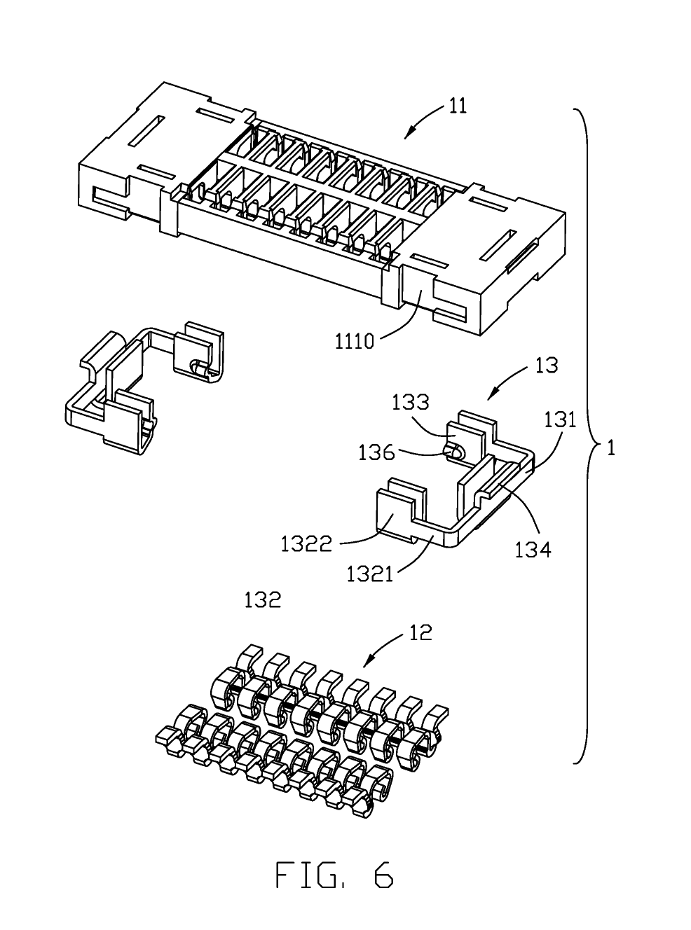

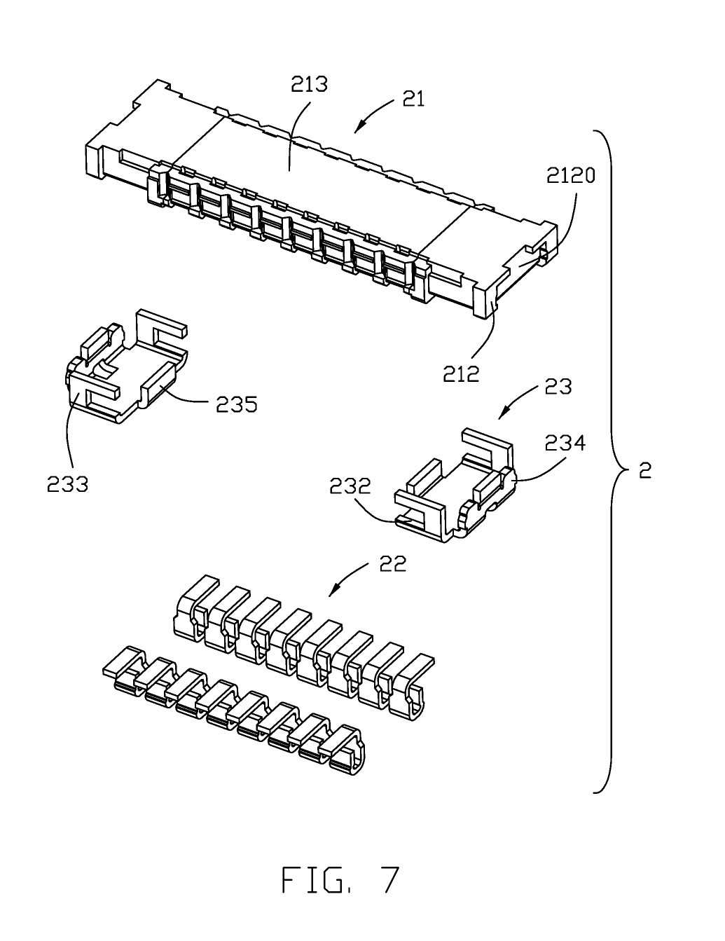

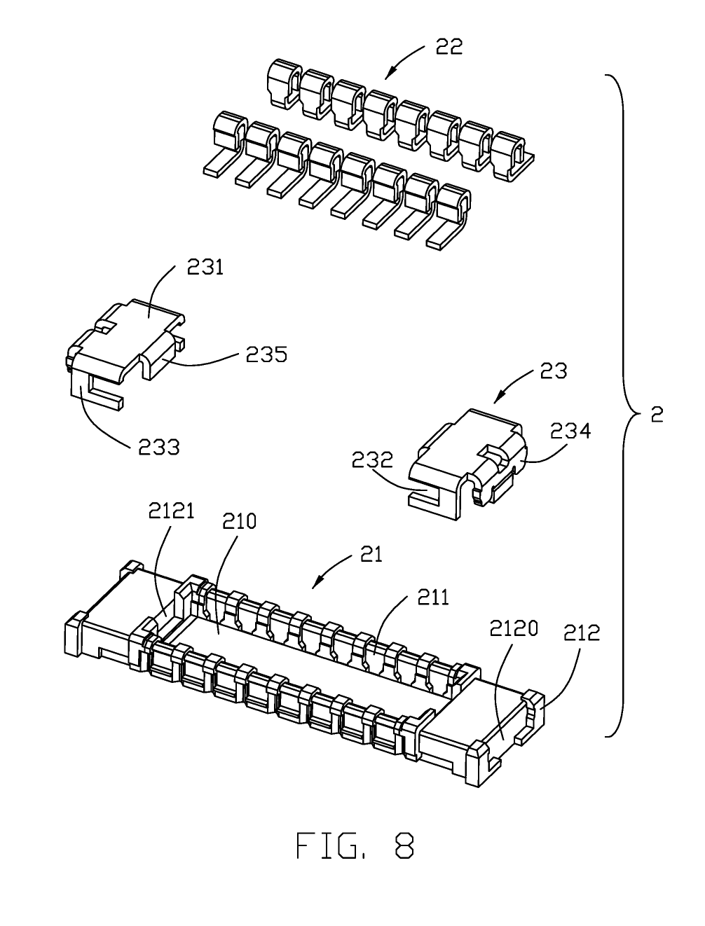

Referring to FIGS. 1 through 8, an electrical connector assembly 100 in accordance with a first embodiment of the present invention includes a receptacle connector 1 and a mating plug connector 2. The receptacle connector 1 comprises an insulative housing 11, a plurality of contacts 12 secured to the housing 11, and a pair of holding members 13. The plug connector 2 comprises an insulative housing 21, a plurality of contacts 22 secured to the housing 21, and a pair of holding members 23.

The housing 11 includes two side walls 111, two end walls 112, a bottom wall 113, and a land 114, which together define a receiving recess 110. Contact receiving grooves are formed between the two side walls 111 and the land 114 for accommodating two rows of contacts 12. Part of the holding member 13 is disposed in a groove 1110 of the side wall 111 facing outwardly.

The holding member 13 is integrally formed, i.e., insert molded, at an end portion of the housing 11. The holding member 13 includes a base 131, a pair of arms 132 extending from the base 131, and a pair of contact portions 133 bent inwardly from the arms 132. The base 131 is embedded in the housing 11. The holding member 13 further includes a head 134 and a tail bent from an upper and a lower of the base 131, respectively. The contact portion 133 has a locking protrusion 136. The arm 132 has a first part 1321 and a second part 1322 in the form of T-shape and is generally flush with the outer surface of the side wall 111. The second part 1322 and the contact portion 133 forms a U-shape.

The housing 21 includes two side walls 211, two end walls 212, and a bottom wall 213, which together define a receiving recess 210. Grooves 2120 and 2121 are provided on the end wall 212. The contacts 22 are insert molded with the housing 21 in two rows.

The holding member 23 is integrally formed, i.e., insert molded, at an end portion of the housing 21. The holding member 23 includes a main portion 231, a first and second positioning portions 234 and 235, and a pair of contact portions 233 extending from the main portion 231. The first and second positioning portions 234 and 235 are mounted to the grooves 2120 and 2121, respectively. The contact portion 233 has a locking notch 232 for engaging the protrusion 136 of the contact portion 133 to form a locking or holding structure.

In use, board-to-board connectors 1 and 2 mate with each other in a known manner with the holding members 13 and 23 locked to each other through the two contact portions 133 and the two contact portions 233.

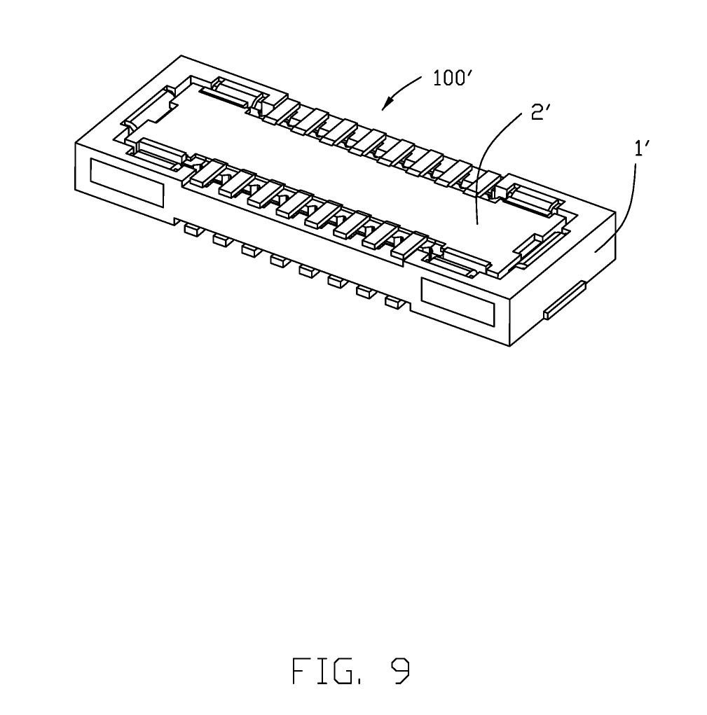

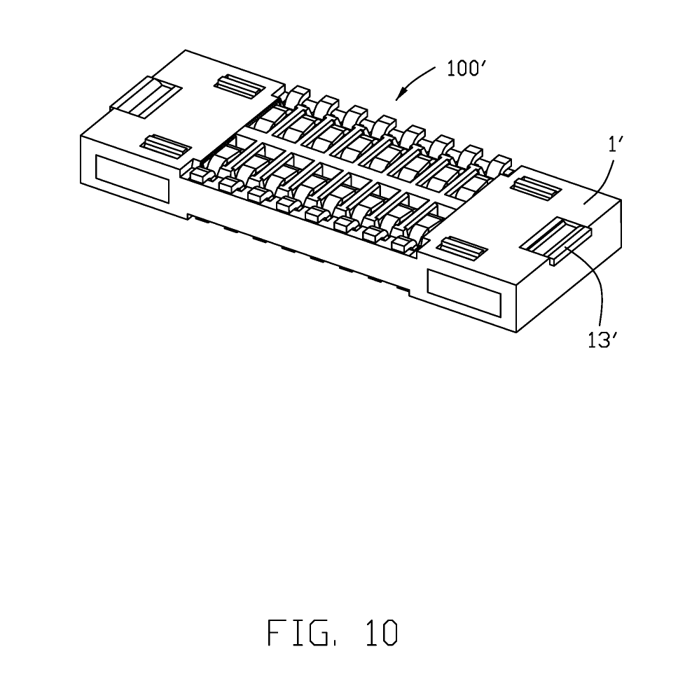

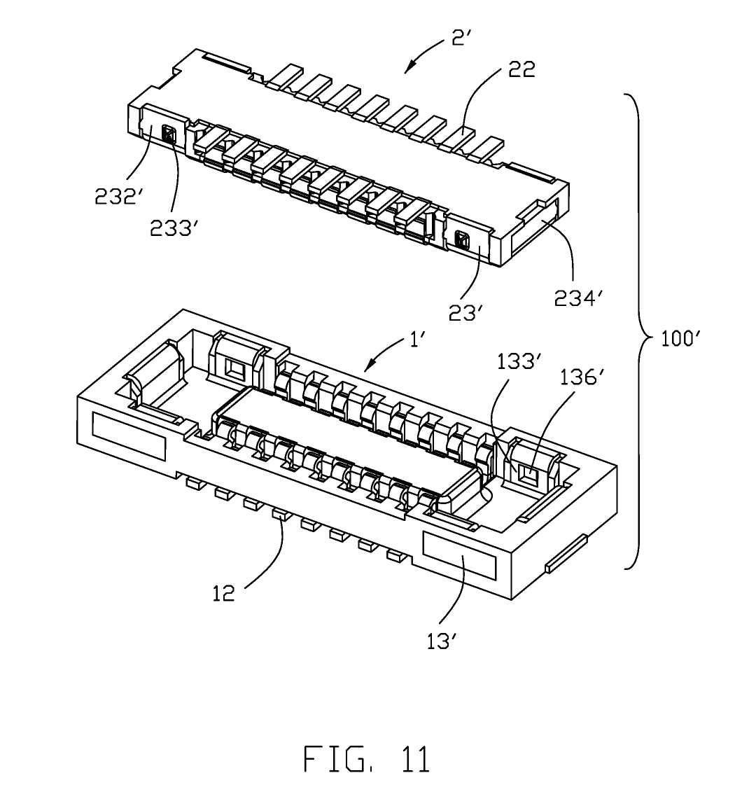

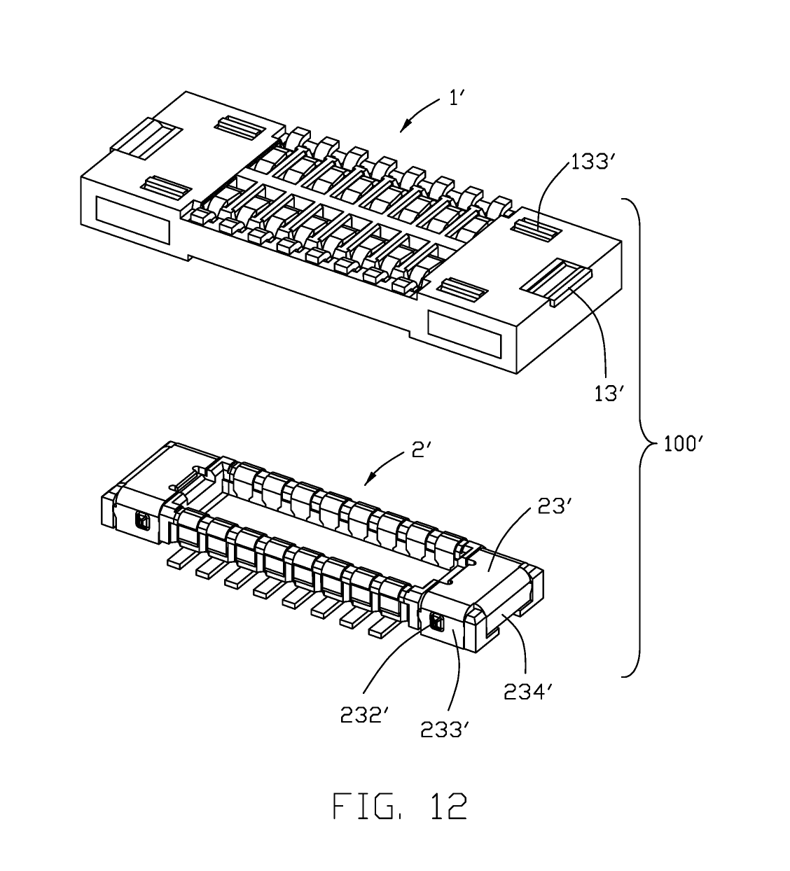

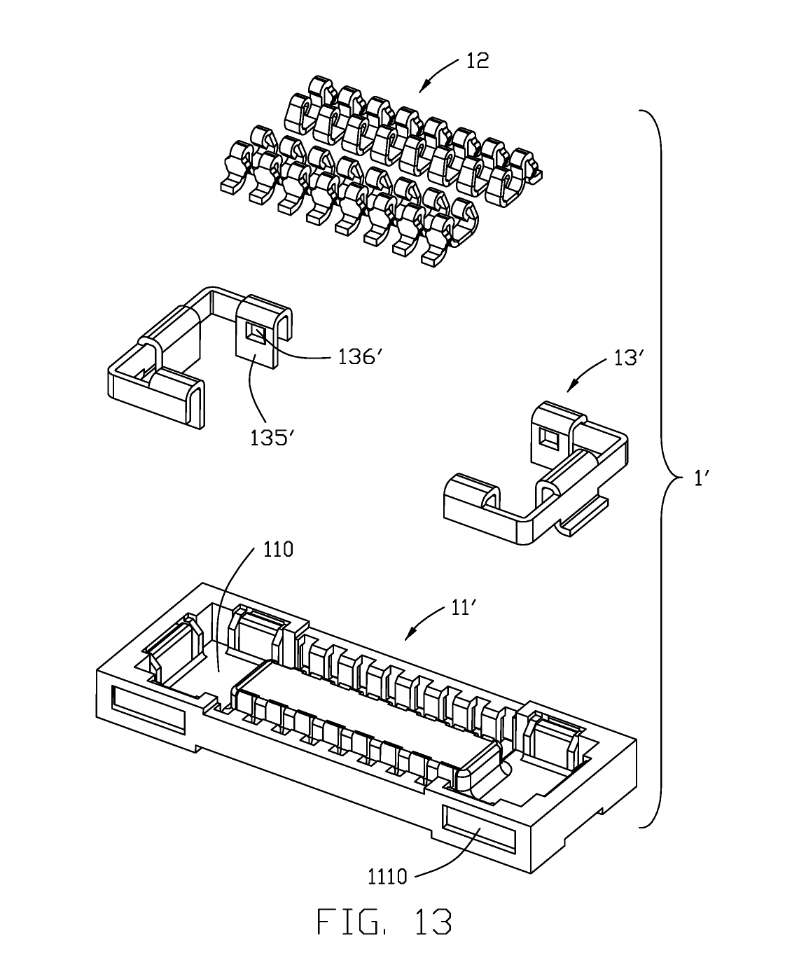

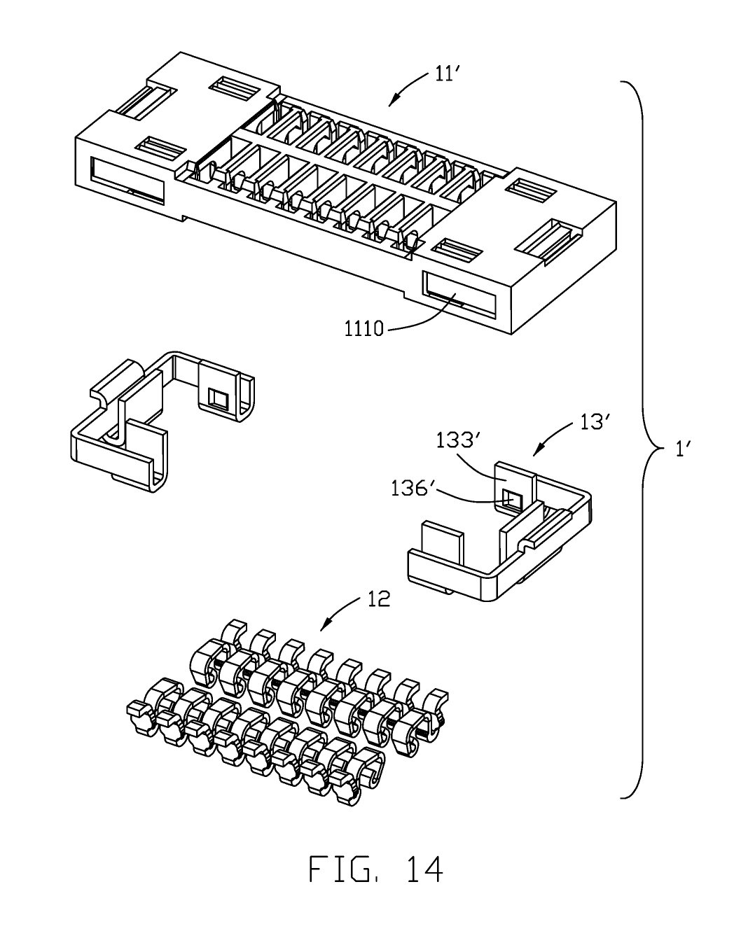

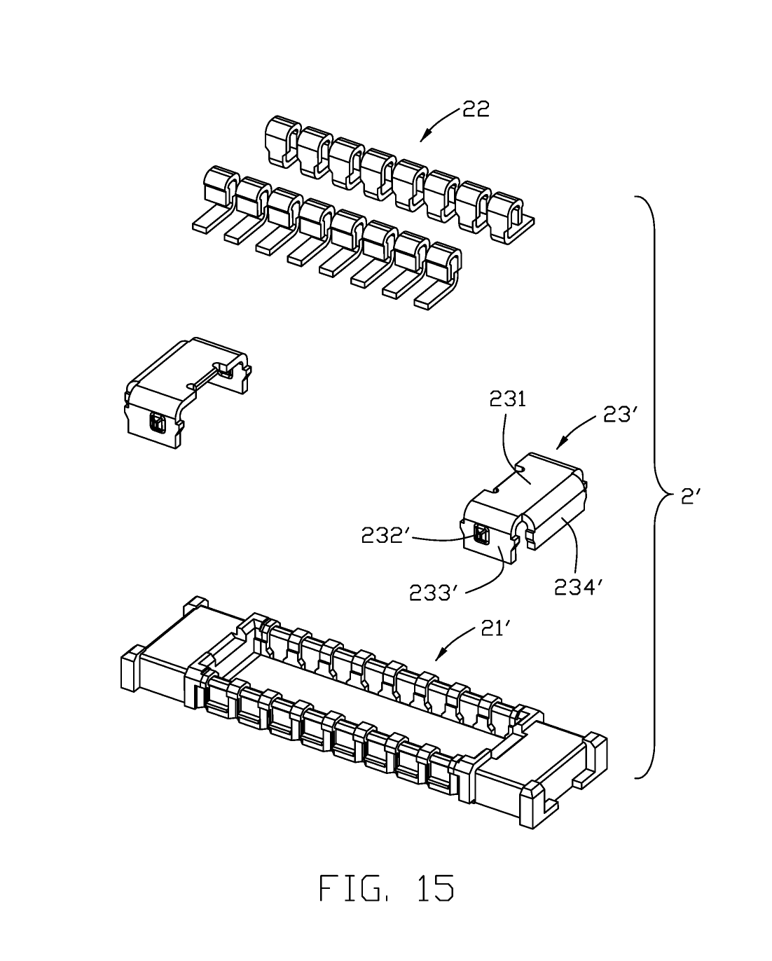

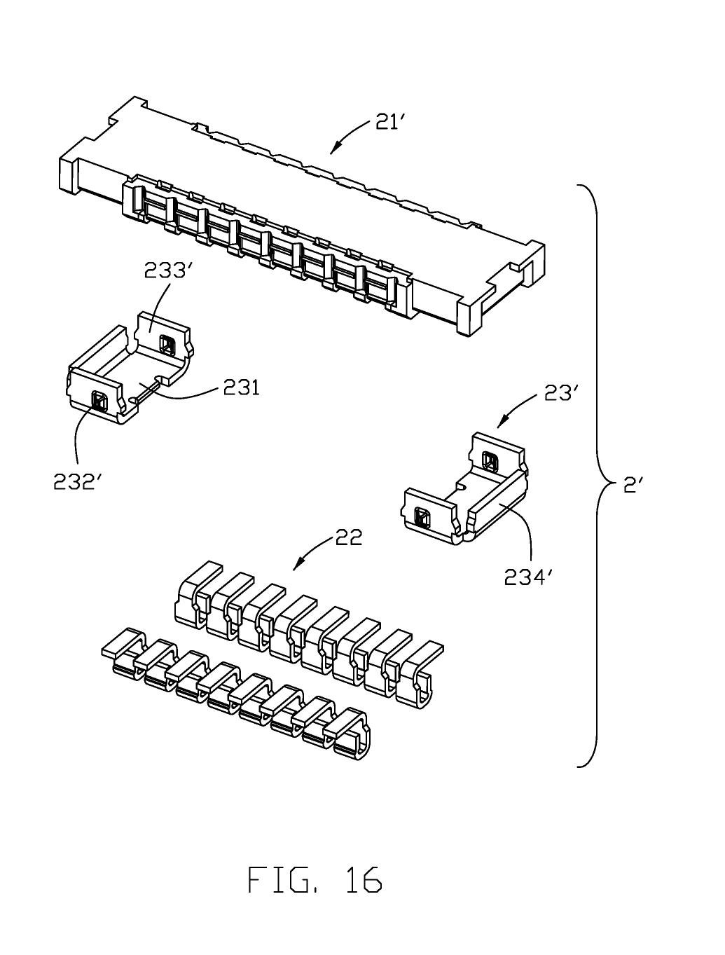

FIGS. 9 through 16 show an electrical connector assembly 100′ in accordance with a second embodiment of the present invention. The electrical connector assembly 100′ includes a receptacle connector 1′ and a mating plug connector 2′. The receptacle connector 1′ comprises an insulative housing 11′, a plurality of contacts 12′ secured to the housing 11′, and a pair of holding members 13′. The plug connector 2′ comprises an insulative housing 21′, a plurality of contacts 22′ secured to the housing 21′, and a pair of holding members 23′.

The holding member 13′ is different from the holding member 13 of the first embodiment in that the contact portion 133′ has a locking notch 136′ instead of a protrusion. The other components and/or parts are essentially same so that same reference numerals plus an apostrophe are used and detailed descriptions thereof are omitted for simplicity and clarity.

Similarly, the holding member 23′ is different from the holding member 23 of the first embodiment in that the contact portion 233′ has a locking protrusion 232′ instead of a notch. The other components and/or parts are essentially same so that same reference numerals plus an apostrophe are used and detailed descriptions thereof are omitted for simplicity and clarity.

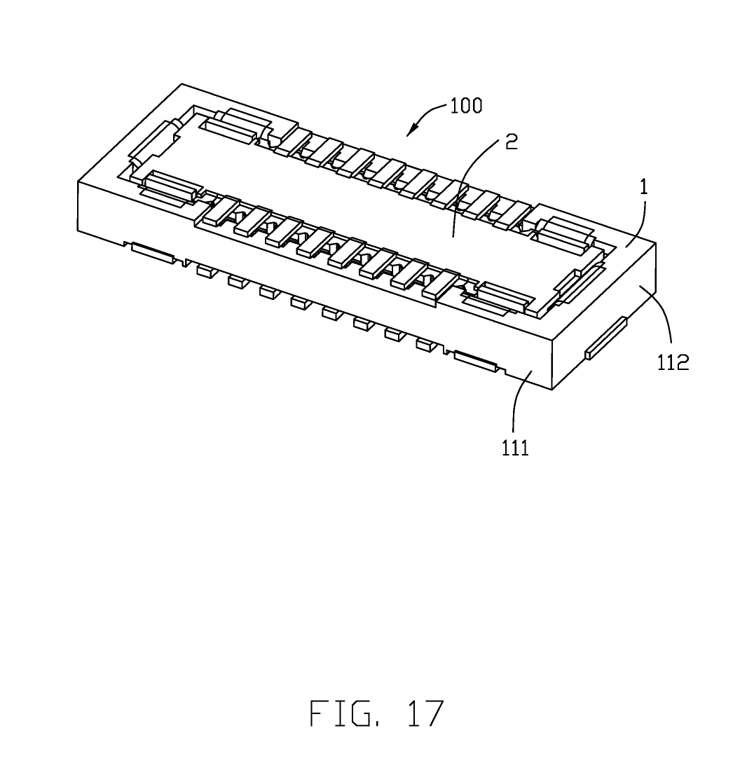

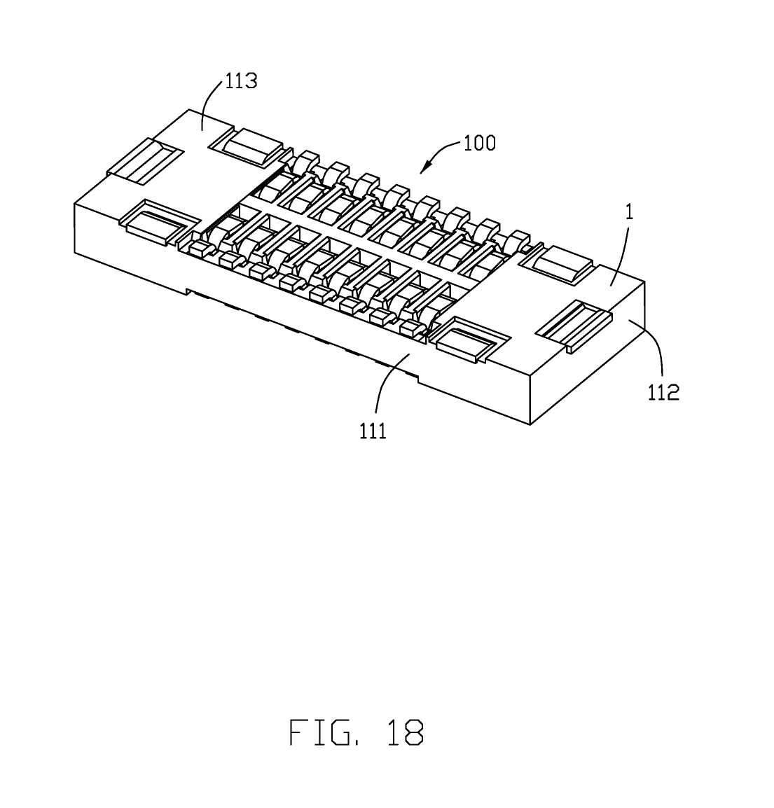

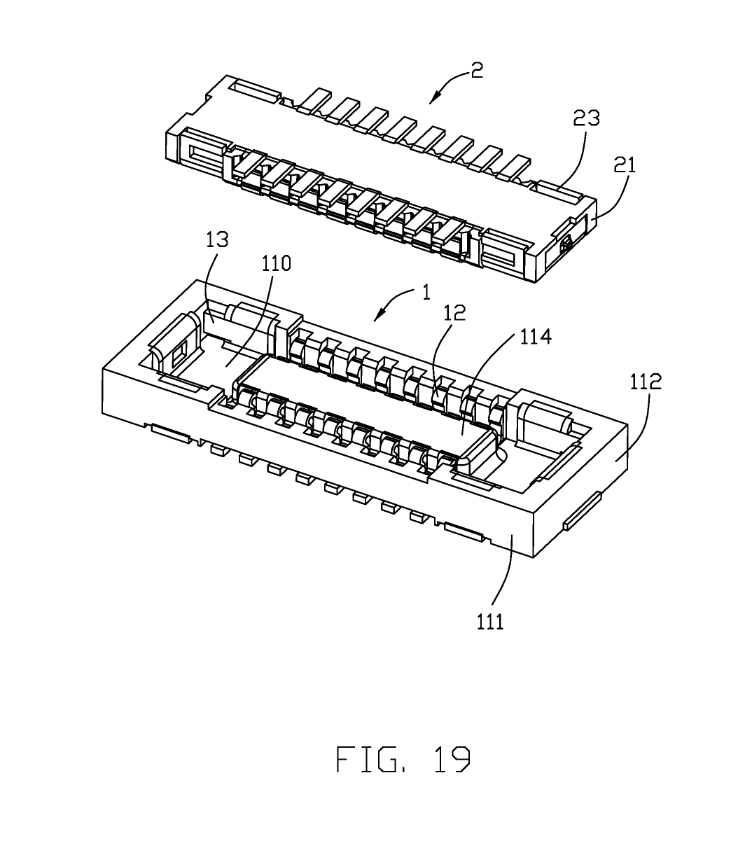

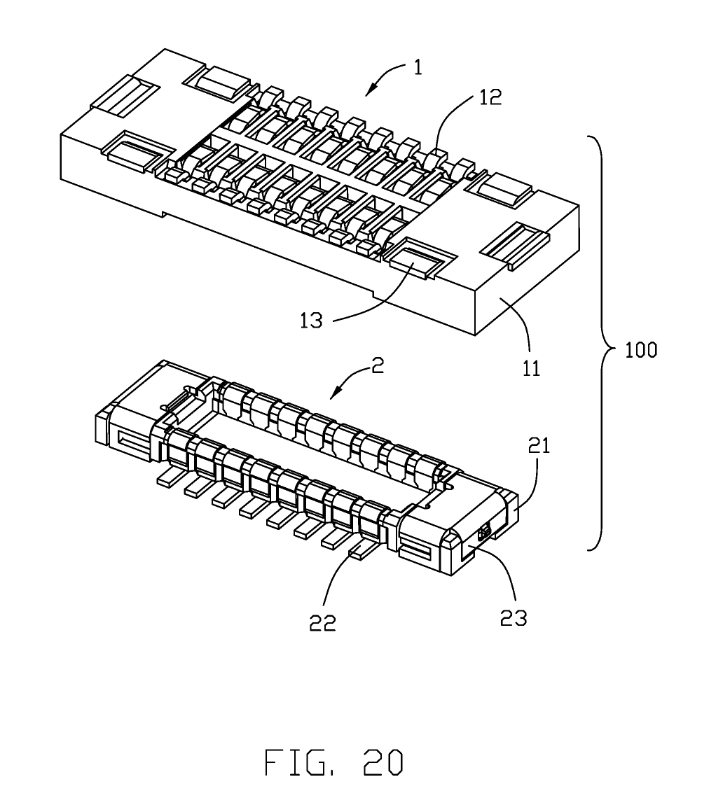

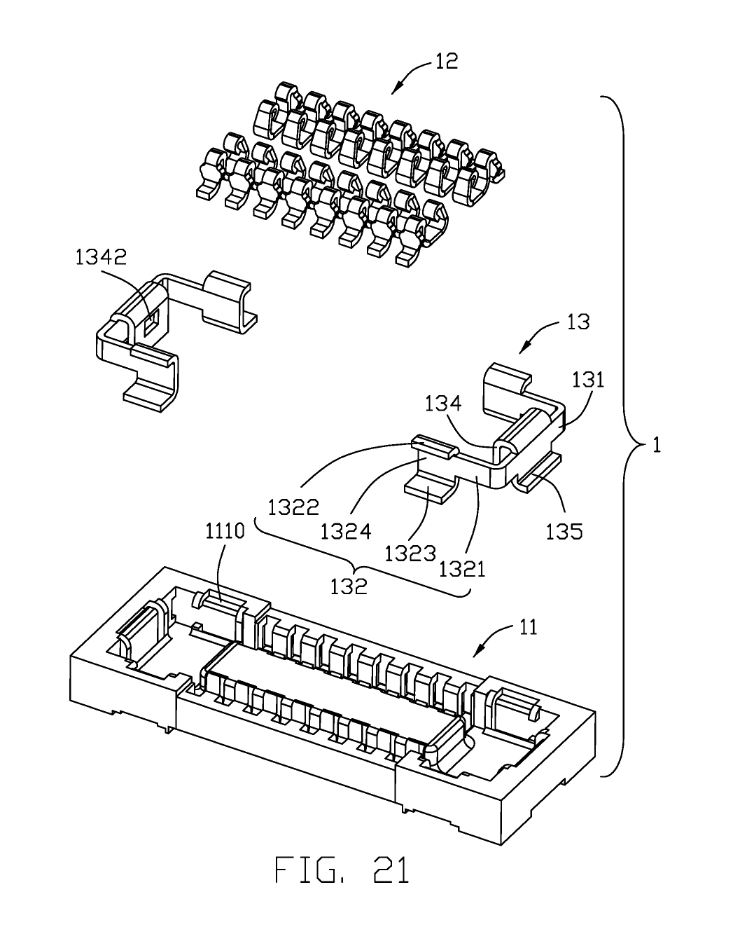

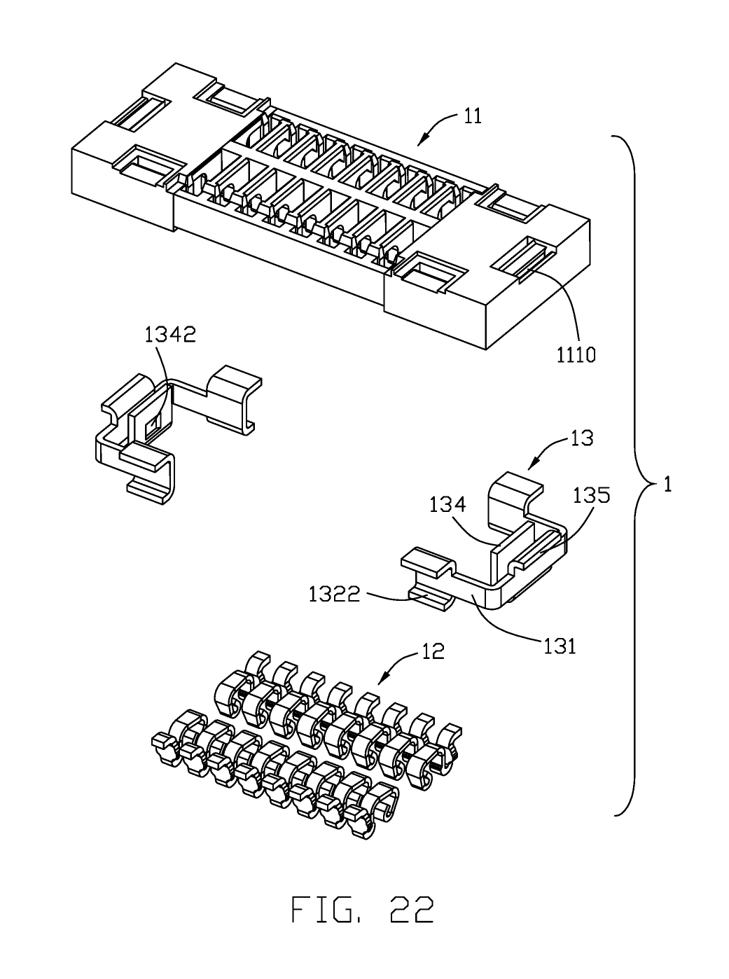

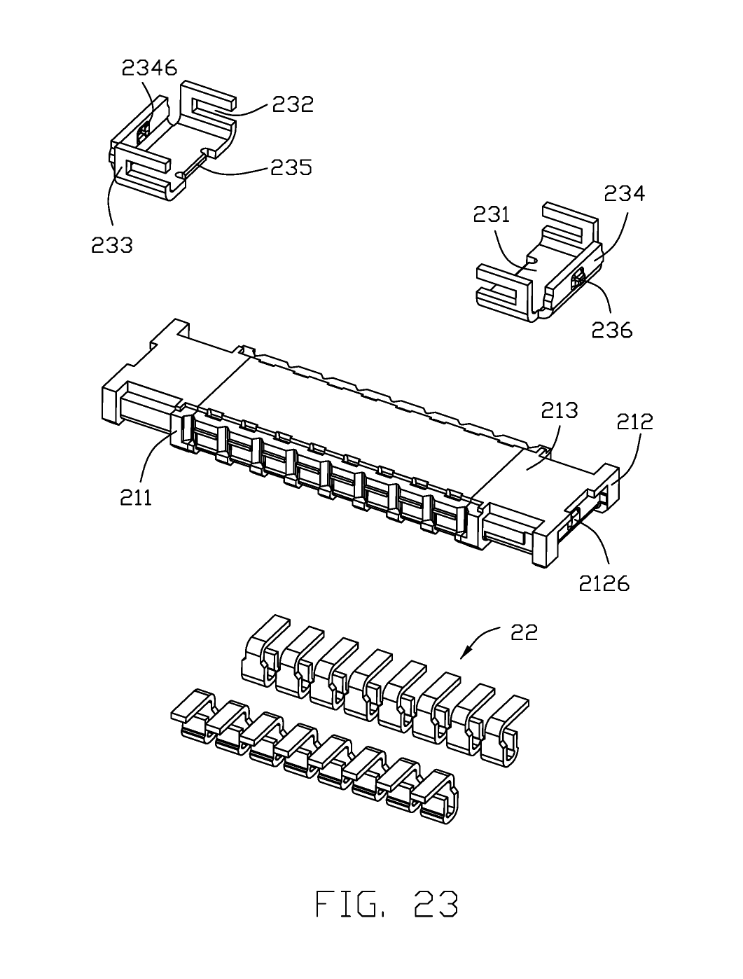

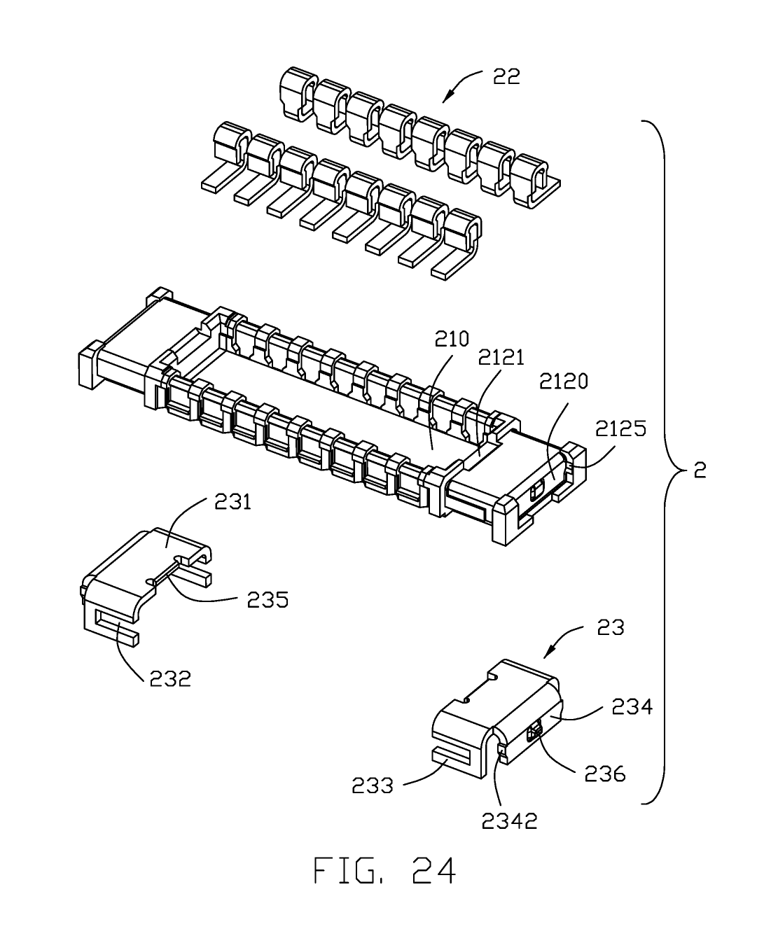

FIGS. 17 through 24 show an electrical connector assembly 100 in accordance with a third embodiment of the present invention. The electrical connector assembly 100 includes a receptacle connector 1 and a mating plug connector 2. The receptacle connector 1 comprises an insulative housing 11, a plurality of contacts 12 secured to the housing 11, and a pair of holding members 13. The plug connector 2 comprises an insulative housing 21, a plurality of contacts 22 secured to the housing 21, and a pair of holding members 23.

Referring to FIGS. 17 through 24, the housing 11 includes two side walls 111, two end walls 112, a bottom wall 113, and a land 114, which together define a receiving recess 110. Contact receiving grooves are formed between the two side walls 111 and the land 114 for accommodating two rows of contacts 12. Part of the holding member 13 is disposed in a groove 1110 of the side wall 111 facing inwardly.

Also referring to FIGS. 17 through 24, the holding member 13 is integrally formed, i.e., insert molded, at an end portion of the housing 11. The holding member 13 includes a base 131, a pair of arms 132 extending from the base 131, and a head 134 bent inwardly from an upper of the base 131. The base 131 is embedded in the housing 11. The head 134 has a locking notch 1342. The holding member 13 further includes a tail bent outwardly from a lower of the base 131. The arm 132 has a first part 1321, a second part 1324, a contact portion 1322, and a leg 1323. The contact portion 1322 is bent outwardly and is insert molded with the housing 11.

Still referring to FIGS. 17 through 24, the housing 21 includes two side walls 211, two end walls 212, and a bottom wall 213, which together define a receiving recess 210. Grooves 2120 and 2121 are provided on the end wall 212. Features 2125 and 2126 are disposed in the groove 2120. The contacts 22 are insert molded with the housing 21 in two rows.

Still referring to FIGS. 17 through 24, the holding member 23 is integrally formed, i.e., insert molded, at an end portion of the housing 21. The holding member 23 includes a main portion 231, a first and second positioning portions 234 and 235, and a pair of contact portions 233 extending from the main portion 231. The first and second positioning portions 234 and 235 are mounted to the grooves 2120 and 2121, respectively. Features 2342 and 236 are disposed on the portion 234 for engaging the features 2125 and 2126, respectively. The contact portion 233 has a notch 232. The feature 236 is in the form of a protrusion for engaging the notch 1342 of the head 134 to form a locking or holding structure.

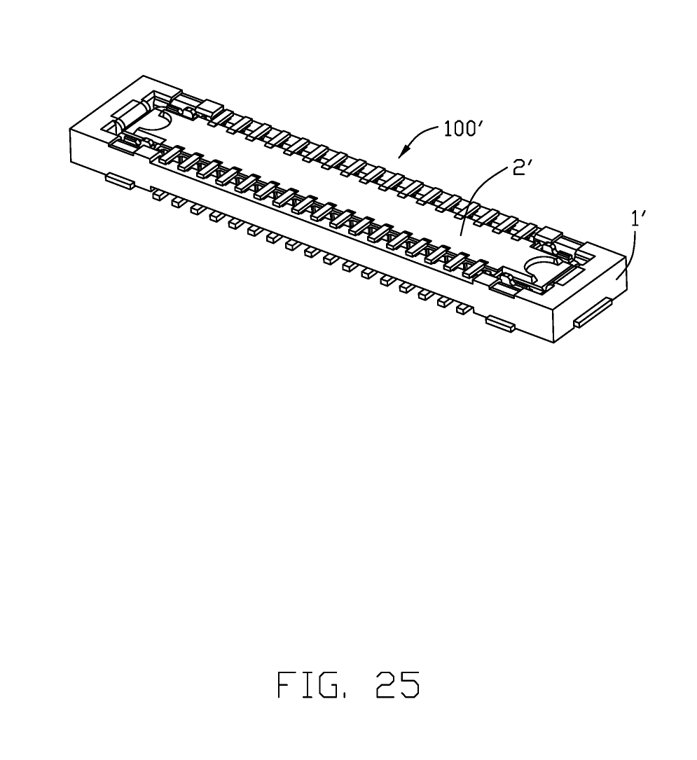

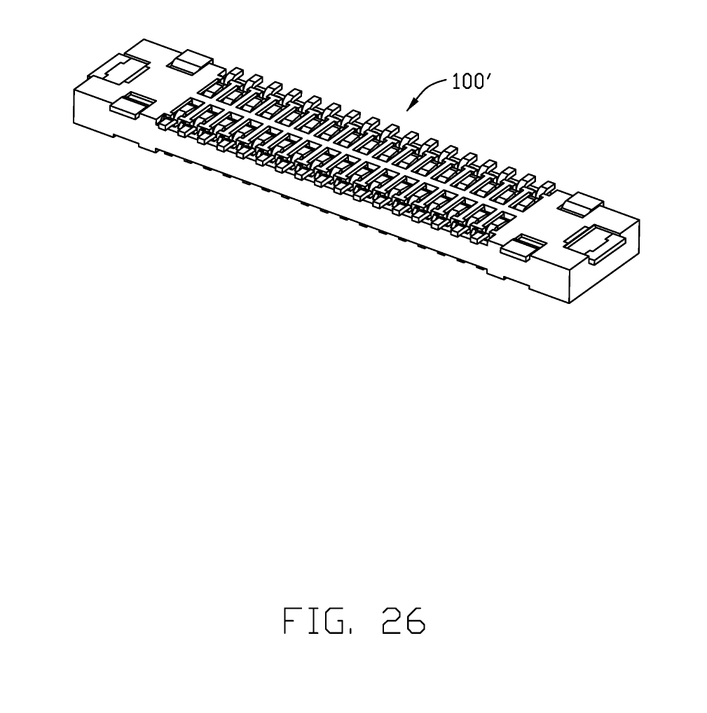

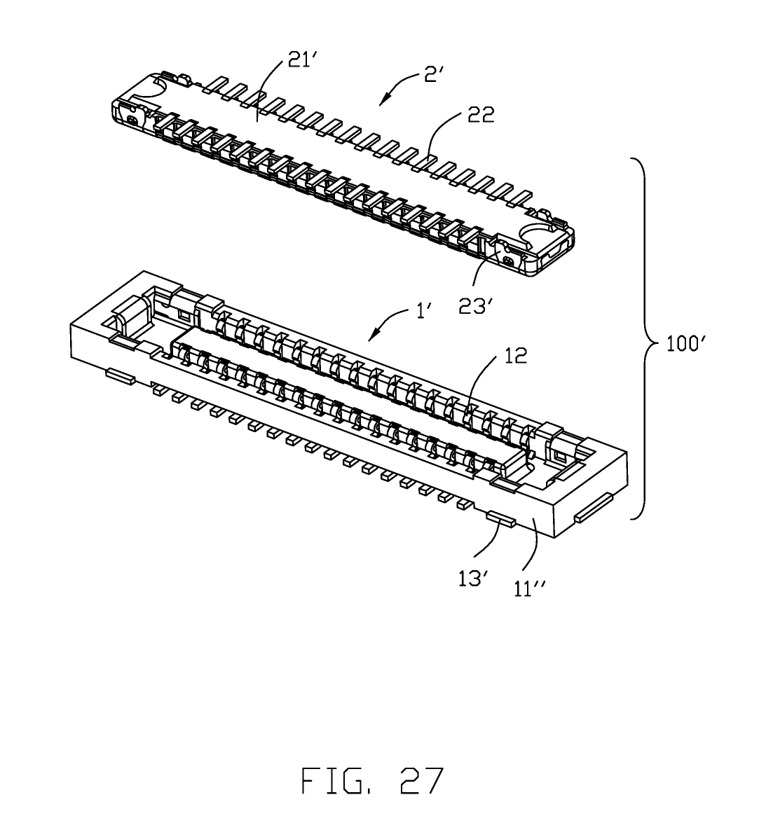

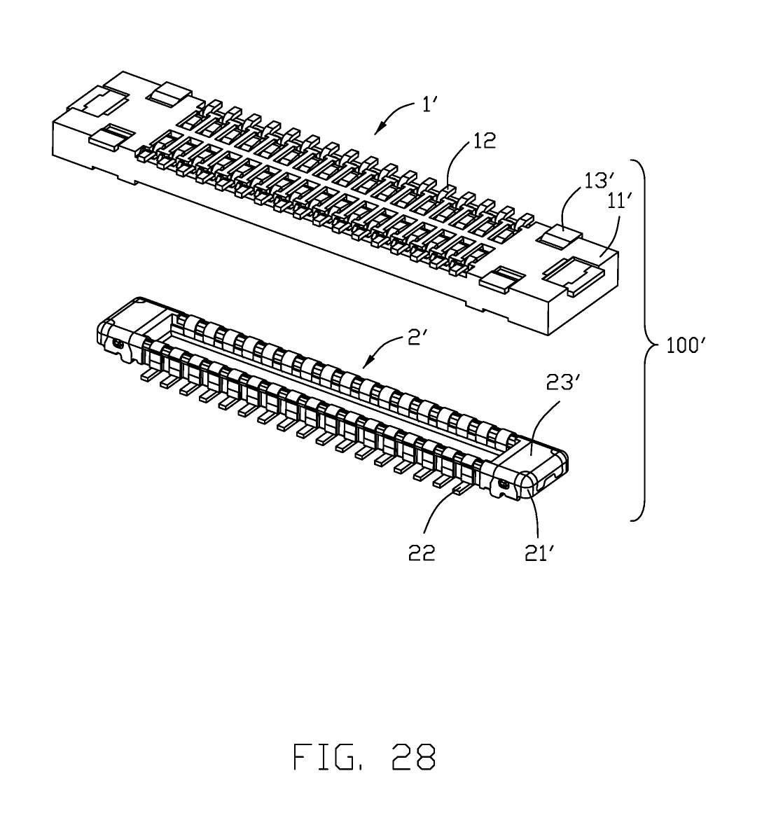

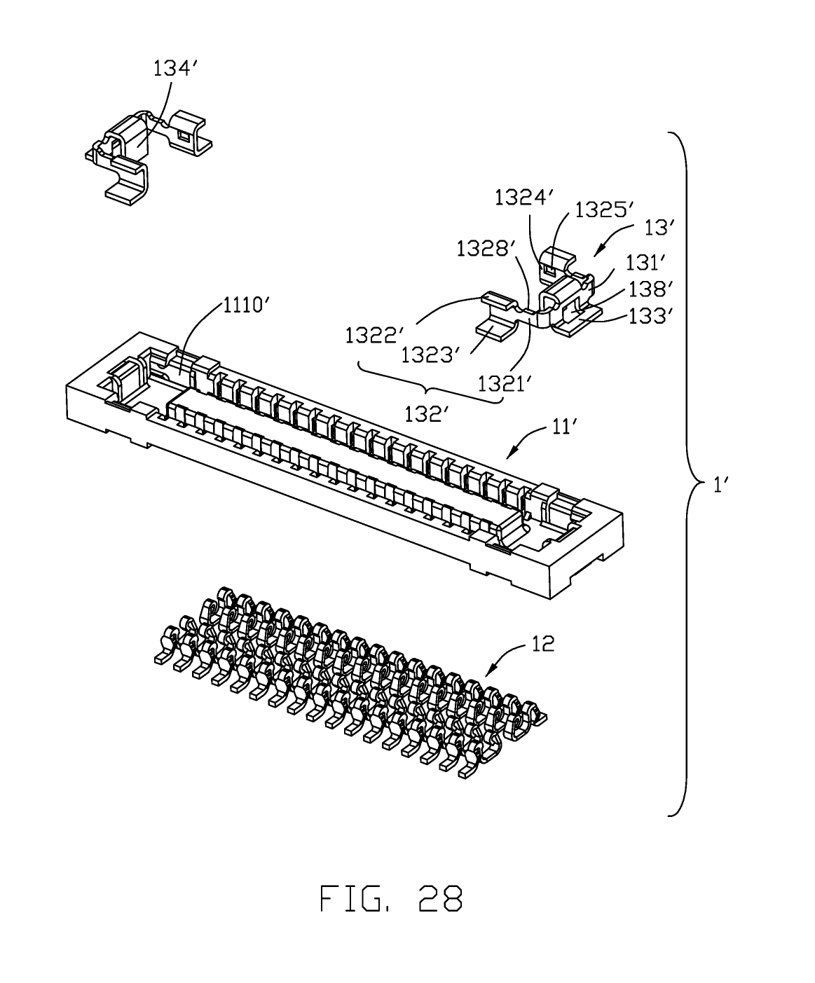

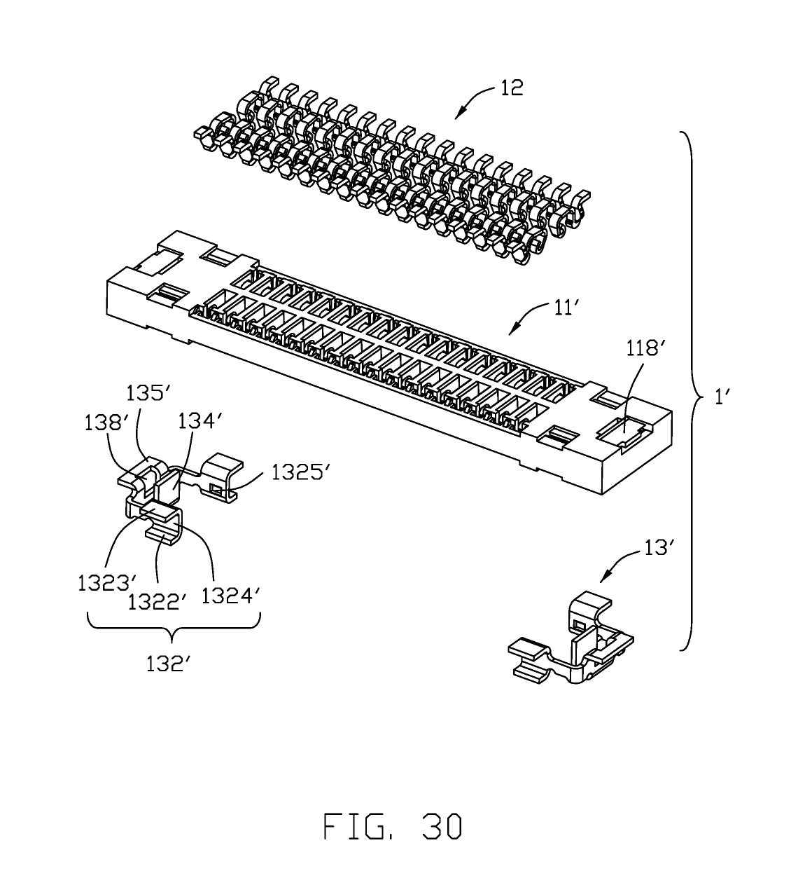

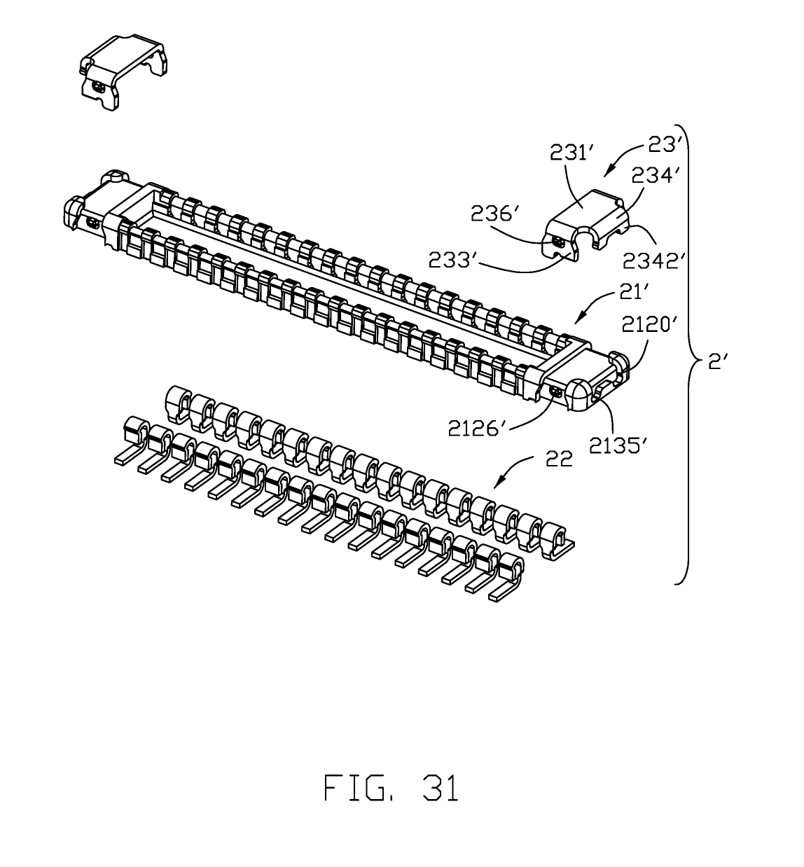

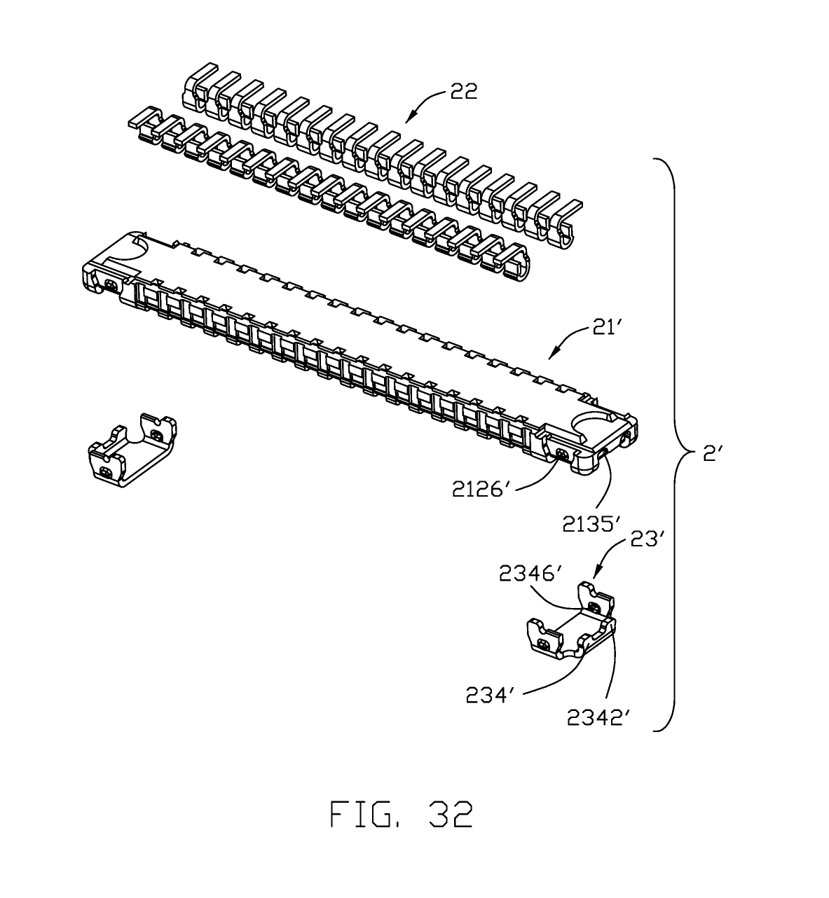

Referring now to FIGS. 25 through 32 which show an electrical connector assembly 100′ in accordance with a fourth embodiment of the present invention. The electrical connector assembly 100′ includes a receptacle connector 1′ and a mating plug connector 2′. The receptacle connector 1′ comprises an insulative housing 11′, a plurality of contacts 12′ secured to the housing 11′, and a pair of holding members 13′. The plug connector 2′ comprises an insulative housing 21′, a plurality of contacts 22′ secured to the housing 21′, and a pair of holding members 23′.

Still referring to FIGS. 25 through 32, the holding member 13′ is different from the holding member 13 of the third embodiment in that a locking notch 1325′ is disposed on a second part 1324′ of an arm 132′ instead of the locking notch 1342 on the head 134. Similarly, the holding member 23′ is different from the holding member 23 of the third embodiment in that a locking protrusion 236′ is disposed on a contact portion 233′ instead of the locking notch 232 on the contact portion 233. And features 2126′, 2135′, 2342′ are correspondingly provided. The other components and/or parts are essentially same so that same reference numerals plus an apostrophe are used and detailed descriptions thereof are omitted for simplicity and clarity.

What is claimed is:

1. An electrical connector comprising:
an insulative housing;
a plurality of contacts secured to the insulative housing; and
a pair of holding members insert molded with the insulative housing, the holding member including a base, a pair of arms extending from the base, and a pair of contact portions bent inwardly from the arms; wherein the base is embedded in the insulative housing.

2. The electrical connector as claimed in claim 1, wherein each contact portion has a locking protrusion.

3. The electrical connector as claimed in claim 1, wherein each contact portion having a locking notch.

4. The electrical connector as claimed in claim 1, wherein the contact portions are insert molded with the insulative housing.

5. An electrical connector comprising:
an insulative housing;
a plurality of contacts secured to the insulative housing; and
a pair of holding members insert molded with the insulative housing, each holding member including a base, a pair of arms extending from the base, and a head bent inwardly from the base; wherein
the base is embedded in the insulative housing.

6. The electrical connector as claimed in claim 5, wherein the head has a locking notch.

7. The electrical connector as claimed in claim 5, wherein the head is insert molded with the insulative housing.

8. The electrical connector as claimed in claim 5, wherein each arm has a locking notch.

9. The electrical connector as claimed in claim 5, wherein each arm includes a contact portion bent outwardly and insert molded with the insulative housing.

10. The electrical connector as claimed in claim 5, wherein each holding member includes a tail bent outwardly from the base, and a hole is provided at a junction between the base and the tail.

11. An electrical connector assembly comprising:
a first electrical connector and a second electrical connector mated together, said first electrical connector including:
a first insulative housing extending along a longitudinal direction and defining therein a first receiving recess;
two rows of first contacts disposed in the first housing and located by two sides of the first receiving recess, and each row of said two rows of the first contacts extending along said longitudinal direction;
a pair of first holding members embedded at two opposite ends of the first housing via an insert-molding process;
said second electrical connector including:
a second insulative housing extending along the longitudinal direction and defining therein a second receiving recess;
two rows of second contacts disposed in the second housing and located by two sides of the second receiving recess, and each row of said two rows of second contacts extending along said longitudinal direction;
a pair of second holding members secured at two opposite ends of the second housing via an inserting operation; wherein
during mating, the second housing is received within the first receiving recess and the pair of first holding members are engaged with the corresponding pair of second holding members; wherein
for each first holding member and the corresponding second holding member, at least one locking protrusion is formed on said first holding member and the corresponding second holding member, and at locking notch is formed in the other of said first holding member and the corresponding second holding member.
